(19) United States
(12) Patent Application Publication
(10) Pub. No.: US 2006/0072718 A1
(43) Pub. Date: Apr. 6, 2006

(54) Method for exchanging messages between an end subscriber and a text message server and a telecommunication network and service computer for this

(75) Inventors: Klaus Satzke, Tamm (DE); Volker Laible, Stuttgart (DE); Stefan Wahl, Schwieberdingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/224,287

(22) Filed: Sep. 13, 2005

(30) Foreign Application Priority Data
Oct. 4, 2004 (EP) 04 292 352.4

(51) Int. Cl. H04M 1/64

(52) U.S. Cl. 379/88.17

(57) ABSTRACT

The invention relates to a method for exchanging messages between an end subscriber and a text message server in a telecommunication network via even a conventional telephone device, which is connected to the text message server via a gateway with browser, which has means for voice recognition and for converting text into speech, and a service computer, wherein according to the end subscriber's instructions given by speech and/or via the keypad of the telephone device the gateway with browser contacts the service computer and from there downloads an electronic document, the gateway with browser converts indications, instructions and/or text messages from text into speech by means of the electronic document and outputs them on the telephone device and the gateway with browser receives instructions and/or messages which the end subscriber has input by speech and/or via the keypad of the telephone device, voice messages being converted into text messages in the gateway with browser, and also a telecommunication network and a service computer for this.

The invention is based on a priority application EP 04 292 352.4 which is hereby incorporated by reference.

### TECHNICAL FIELD

The invention relates to a method for exchanging messages between an end subscriber and a text message server in a telecommunication network via even a conventional telephone device, which is connected to the text message server via a gateway with browser, which has means for voice recognition and for converting text into speech, and a service computer, a telecommunication network for executing a method for exchanging messages between an end subscriber and a text message server via even a conventional telephone device, which is connected to the text message server via a gateway with browser and a service computer for executing a method for exchanging messages between an end subscriber and a text message server via even a conventional telephone device, which is connected to the text message server via a gateway with browser and the service computer.

### BACKGROUND OF THE INVENTION

So-called instant messaging (IM), in which instant messages, i.e. text messages, can be sent, in the simplest case simply by one click of the mouse, between end subscribers who are currently logged on to the instant messaging system, has become established in recent years as a new form of communication via the internet with the possibility of a very quick reply to messages. Additionally, under the name Push-To-Talk (PTT) a communications architecture has been introduced, in which it is possible to communicate very quickly with one or more other end subscribers entered in a so-called buddy list simply by pressing a key of a PTT-capable telephone, without the person called having to accept the call explicitly. On the other hand, the use of voice services based, e.g., on the so-called Voice extensible Markup Language (VoiceXML) and in which, e.g., e-mails or short message services (SMS) from a special gateway with browser are converted into speech and read out to the end subscriber over any telephone device has also increased enormously.

However, to date there is no interface between instant messaging systems and the so-called plain old telephone system (POTS), in which only analog telephone devices are used, i.e. end subscribers with a POTS telephone currently do not have the possibility of having instant messages sent to them as voice messages. Furthermore, until now it has not been provided in the architecture of Voice XML for speech to be directly converted into text, which would greatly restrict the possibility of answering instant messages by means of speech in any future use of VoiceXML in connection with instant messages.

### SUMMARY OF THE INVENTION

The object of the invention is to create a remedy for the situation described above.

This object is achieved according to the invention by a method for exchanging messages between an end subscriber and a text message server in a telecommunication network via even a conventional telephone device, which is connected to the text message server via a gateway with browser, which has means for voice recognition and for converting text into speech, and a service computer, wherein according to the end subscriber's instructions given by speech and/or via the keypad of the telephone device the gateway with browser contacts the service computer and from there downloads an electronic document, in that the gateway with browser converts indications, instructions and/or text messages from text into speech by means of the electronic document and outputs them on the telephone device, in that the gateway with browser receives instructions and/or messages which the end subscriber has input by speech and/or via the keypad of the telephone device, voice messages being converted into text messages in the gateway with browser, in that these instructions and/or text messages are sent on to the service computer and/or the text message server and in that indications, instructions and/or text messages for this end subscriber are sent from the text message server to the service computer and/or via the gateway with browser to the telephone device, a telecommunication network for executing a method for exchanging messages between an end subscriber and a text message server via even a conventional telephone device, which is connected to the text message server via a gateway with browser, wherein between the gateway with browser and the text message server there is a service computer which has means for making available to the gateway with browser electronic documents for downloading, by means of which the gateway with browser converts indications, instructions and/or text messages from text into speech and outputs them on the telephone device and for sending, storing and receiving indications, instructions and/or text messages and a service computer for executing a method for exchanging messages between an end subscriber and a text message server via even a conventional telephone device, which is connected to the text message server via a gateway with browser and the service computer, wherein the service computer has means for making available to the gateway with browser electronic documents for downloading, by means of which the gateway with browser converts indications, instructions and/or text messages from text into speech and outputs them on the telephone device and for receiving, storing and sending indications, instructions and/or text messages.

The invention is based on the idea that instant messages servers of various providers, such as, e.g. MSN, Yahoo or AOL, are connected to a service computer, which is in turn connected via a telecommunication network to a telephone device, in particular to a POTS telephone, via a gateway with browser equipped with the capability of voice recognition and the conversion of text into speech. The instant messages servers can send instant messages to the service computer or receive instant messages from it. The service computer generates electronic documents in which the received instant messages are integrated and the gateway with browser can download these electronic documents. The electronic documents additionally contain instructions and indications in a form which the gateway with browser can interpret and with the help of which it can convert the instant messages from text into speech and can output these converted messages together with instructions and indications as speech on any telephone device. In this way the end subscriber using a POTS telephone can continue to use it and does not have to acquire another telephone device and learn how it works. The end subscriber can reply to the voice messages and instructions by selecting pre-defined replies or instructions by means of a voice-operated menu by pressing a key or by speech or by inputting any voice message as reply to an instant message. Then, in the gateway with browser on the one hand voice messages are converted into text and on the other hand instructions are evaluated and then the text messages and the evaluated instructions are sent to the service computer and if applicable forwarded to the appropriate instant messages server. A so-called presence server, in which the status of the individual end subscribers to the instant messages service is stored, such as, e.g. whether or not the end subscriber is currently online, can be connected to the service computer and the information on the status of selected end subscribers entered in a buddy list can be sent to the individual end subscribers.

Further configurations of the invention are to be found in the subordinate claims and the following description.

### BRIEF DESCRIPTION OF THE DRAWINGS

The invention is explained in greater detail below with the aid of the attached drawing.

FIG. 1 shows by way of example a network environment in which the invention is implemented.

### DETAILED DESCRIPTION OF PREFERRED EMBODIMENTS

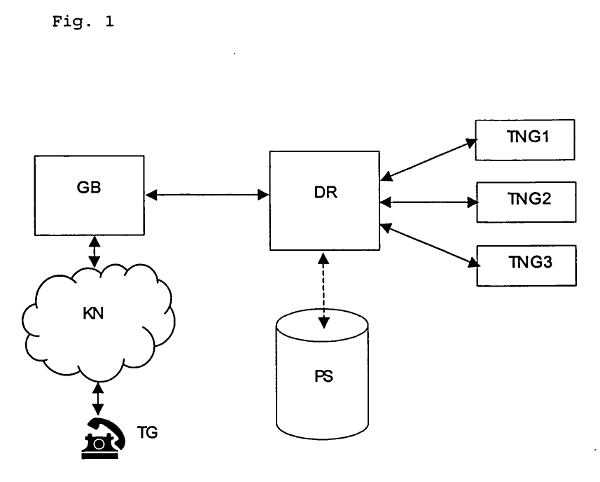

The telecommunication network according to the invention illustrated in FIG. 1 includes telephone devices TG, only one telephone device TG being illustrated in FIG. 1 as an example, a gateway with browser GB, a service computer DR, text message gateways TNG1-TNG3, three being illustrated in FIG. 1, again by way of example, and also a presence server PS.

The telephone devices TG are connected to the gateway with browser GB via bi-directional fixed network or mobile connections KN, such as, e.g. POTS or Global System for Mobile Communication (GSM), including network nodes, such as, e.g. access points, routers or switches. The gateway with browser GB in turn has a bi-directional communication connection, e.g. via the internet, to the service computer DR. The service computer DR is connected via bi-directional communication connections, such as, e.g. the internet, to the various text message gateways TNG1-TNG3. The forwarding connections of the text message gateways TNG1-TNG3 to the appropriate text message servers in each case are not illustrated in FIG. 1.

In the example cited the service computer DR is still additionally connected to the presence server PS via a bi-directional communication connection, such as, e.g. the internet, representing, though, only an optional embodiment of the invention.

The telephone devices TG can be of any kind, such as, e.g. ISDN telephones (ISDN=Integrated Services Digital Network), mobile telephones or in particular also POTS telephones.

The gateway with browser GB has capabilities for voice recognition and for converting text into speech and speech into text and by means of these capabilities can download electronic documents from servers and output the contents as speech to the end subscriber on the telephone device TG, receive voice and text messages, convert them into text or speech and send them and receive voice and/or text instructions and execute or forward them. The gateway with browser GB is thus similar to a VoiceXML gateway, such as, e.g. sold by VoiceGenie or Tellme, wherein, though, the current VoiceXML version 2.0 does not support the direct conversion of speech into text.

The service computer DR according to the invention is a computer which fulfils special functions required for implementing the method according to the invention for exchanging messages. For this purpose the service computer DR has means for making available to the gateway with browser GB electronic documents for downloading, by means of which the gateway with browser GB converts indications, instructions and/or text messages from text into speech and outputs them on the telephone device TG, and for receiving, storing and sending indications, instructions and/or text messages. Additionally, the service computer DR can fulfil further tasks, thus acting, e.g. as web server.

In the example illustrated in FIG. 1 the service computer DR additionally has means for configuring the services for a telephone device TG according to the capacities of the telephone device TG and/or the subscriber profile of the end subscriber associated with the telephone device TG and/or for receiving, storing and sending information on the connection status and/or the capacities of telephone devices TG and/or the subscriber profiles of end subscribers. This, however, represents only an optional embodiment of the invention. By means of the information on the connection status end subscribers can be informed, e.g. which other end subscribers of a previously established group are currently online and thus available for the message exchange, whereas the information on the capacities of the telephone devices TG can be used to be able to provide suitable services depending on the technical data of the telephone devices TG, such as, e.g. the possibility of text input with telephone devices TG which do not belong to the group of POTS telephones. The information on the subscriber profiles of end subscribers is finally used by the service computer DR to configure the services for the individual end subscribers according to their preset wishes. For example, an end subscriber can establish that he wants to receive messages on his POTS telephone from selected further end subscribers only.

The text message gateways TNG1-TNG3 execute, e.g. the adaptation or transfer between the protocols used by text message servers, such as, e.g. ICQ or AIM, and the protocols in public networks and can additionally take on tasks such as, e.g. those of a router. In this way the connection between the service computer DR and the appropriate text message servers in each case is produced by means of the text message gateways TNG1-TNG3.

The presence server PS can store, update, send and receive both information on the connection status of the individual telephone devices TG and information on the capacities of the individual telephone devices TG and on the subscriber profiles of the end subscribers associated with the individual telephone devices TG.

Using FIG. 1, the method according to the invention is now explained below by way of example. By means of the telephone device TG an end subscriber can produce the connection to the gateway with browser GB by dialling a special telephone number. The gateway with browser GB sends an instruction for communicating information on the desired connection to the telephone device TG by means of speech and/or text. Thereupon the end subscriber inputs on the telephone device TG via the keypad and/or by speech to which text message server he would like to be connected and additionally communicates the password by which his access to the text messages intended for him is protected.

According to the end subscriber's instructions, the gateway with browser GB sends to the service computer DR the instruction to contact the desired text message server, together with the password. The service computer DR then conducts the instruction with password via the appropriate text message gateway to the desired text message server. This in turn, after positive identification of the end subscriber, from now on sends the text messages received from other end subscribers and addressed to the end subscriber to the service computer DR.

After positive identification, the information that the end subscriber is online is additionally sent from the service computer DR to the presence server PS and also stored there. The presence server PS additionally sends both information on which of the further end subscribers on the end subscriber's buddy list are currently online and information on the capacities of the end subscriber's telephone device TG and his subscriber profile to the service computer DR.

The services for the telephone device TG are configured in the service computer DR according to the information on the capacities of the telephone device TG. For example, POTS telephones are thereby not offered a service requiring the input of text.

The end subscriber can additionally configure his subscriber profile, which can be stored in the presence server PS, e.g. by communicating via the gateway with browser GB and the service computer DR to the presence server PS that, depending on the capacity of the telephone device TG used, he wishes to receive messages from selected further end subscribers only. The service computer DR will in this case use the information communicated by the presence server PS on the capacity and the subscriber profile associated with the telephone device TG used to forward to the end subscriber messages from these selected further end subscribers only.

The service computer DR now generates electronic documents in which on the one hand the text messages received and on the other hand instructions and indications which relate, e.g., to the connection status of end subscribers on the buddy list are integrated and these electronic documents are then communicated to the gateway with browser GB.

In the gateway with browser GB the electronic documents received from the service computer DR are interpreted by the browser and the browser extracts indications and instructions intended for the end subscriber and outputs them by means of speech and/or text on the telephone device TG. For example, the names of those further end subscribers who are currently online and are therefore available for communication are communicated to the end subscriber by speech. Also, all the text messages arriving in the gateway with browser GB, for example, are converted from text into speech and read out to the end subscriber via the telephone device TG.

The end subscriber can reply to instructions and/or text messages by speech and/or text input on the keypad of the telephone device TG, depending on the capacity of the telephone device TG. The end subscriber can in this case input the replies freely formulated and therefore unstructured and, depending on the capacity of the telephone device TG, can use for this the functionality of dictionaries, which is implemented either in the telephone device TG itself or else in the telecommunication network. Alternatively to this, the end subscriber can select from a large number of predefined messages which are contained, e.g. in the communicated electronic document, and thereby respond to instructions or reply to text messages.

The gateway with browser GB transforms the voice messages received from the telephone device TG into text, if applicable reformats instructions and messages and forwards them to the service computer DR.

In the service computer DR the instructions received from the gateway with browser GB are evaluated and executed or forwarded to the provided receiver, such as, e.g. the presence server PS or a text message server. The text messages received from the gateway with browser GB are sent via the appropriate text message gateway to the text message server addressed.

Should a lower security level suffice for the communication of text messages, the use of a password for identifying the end subscriber can optionally be dispensed with, i.e. knowledge of the telephone number would be adequate in a case of this kind. It is not even absolutely necessary for the end subscriber to be registered as a user of an IM service in order to receive messages, this being necessary only also to be able to send messages.

Where a higher security level is applied for communicating text messages, e.g. if several end subscribers can be reached by one telephone device TG, before communication of each individual text message the input of a password on the telephone device TG may be requested for identification of the end subscriber and the text message is communicated after positive identification. If the end subscriber was not able to be identified as the addressee of the text message, an instruction can still optionally be sent to the telephone device TG and output there, asking the addressee of the text message to come to the telephone device TG.

Alternatively to identification of the end subscriber by a password, any other methods, such as, e.g. biometric methods for voice recognition, or similar, can be used for this.

1. Method for exchanging messages between an end subscriber and a text message server in a telecommunication network via even a conventional telephone device, which is connected to the text message server via a gateway with browser, which has means for voice recognition and for converting text into speech, and a service computer, wherein according to the end subscriber's instructions given by speech and/or via the keypad of the telephone device the gateway with browser contacts the service computer and from there downloads an electronic document, in that the gateway with browser converts indications, instructions and/or text messages from text into speech by means of the electronic document and outputs them on the telephone device, in that the gateway with browser receives instructions and/or messages which the end subscriber has input by speech and/or via the keypad of the telephone device, voice messages being converted into text messages in the gateway with browser, in that these instructions and/or text messages are sent on to the service computer and/or the text message server and in that indications, instructions and/or text messages for this end subscriber are sent from the text message server to the service computer and/or via the gateway with browser to the telephone device.

2. Method according to claim 1, wherein the end subscriber is identified by a password and/or a biometric method before text messages are sent to the telephone device.

3. Method according to claim 1, wherein a presence server connected to the service computer communicates the connection status and/or the capacities of further telephone devices and/or the subscriber profiles of further end subscribers to the service computer.

4. Method according to claim 3, wherein the connection status and/or the capacities of telephone devices of selected end subscribers and/or the subscriber profiles of selected end subscribers are sent by the service computer to the end subscriber's telephone device.

5. Method according to claim 3, wherein the service computer configures the services for the telephone device according to the capacities of the telephone device and/or the subscriber profile of the end subscriber associated with the telephone device.

6. Telecommunication network for executing a method for exchanging messages between an end subscriber and a text message server via even a conventional telephone device, which is connected to the text message server via a gateway with browser, wherein between the gateway with browser and the text message server there is a service computer which has means for making available to the gateway with browser electronic documents for downloading, by means of which the gateway with browser converts indications, instructions and/or text messages from text into speech and outputs them on the telephone device and for sending, storing and receiving indications, instructions and/or text messages.

7. Telecommunication network according to claim 6, wherein a presence server is connected to the service computer, which has means for communicating the connection status and/or the capacities of further telephone devices and/or the subscriber profiles of further end subscribers to the service computer.

8. Service computer for executing a method for exchanging messages between an end subscriber and a text message server via even a conventional telephone device, which is connected to the text message server via a gateway with browser and the service computer, wherein the service computer has means for making available to the gateway with browser electronic documents for downloading, by means of which the gateway with browser converts indications, instructions and/or text messages from text into speech and outputs them on the telephone device and for receiving, storing and sending indications, instructions and/or text messages.

9. Service computer according to claim 8, wherein the service computer has means for receiving, storing and sending information on the connection status and/or the capacities of further telephone devices and/or the subscriber profiles of further end subscribers and/or for configuring the services for the telephone device according to the capacities of the telephone device and/or the subscriber profile of the end subscriber associated with the telephone device.
